(19) United States
(12) Patent Application Publication
(10) Pub. No.: US 2019/0091938 A1
(43) Pub. Date: Mar. 28, 2019

(54) RESIN MOLDED COMPONENT, METHOD FOR PRODUCING RESIN MOLDED COMPONENT, AND METHOD FOR PRODUCING WELDED RESIN-MOLDED ARTICLE

(71) Applicant: TOYODA GOSEI CO., LTD., Kiyosu-shi (JP)

(72) Inventors: Tatsuya MATSUI, Kiyosu-shi (JP); Chiharu TOTANI, Kiyosu-shi (JP); Eiji KOJIMA, Kiyosu-shi (JP)

(21) Appl. No.: 16/038,256

(22) Filed: Jul. 18, 2018

(30) Foreign Application Priority Data
Sep. 28, 2017 (JP) 2017-188826

(51) Int. Cl. B29C 65/14; B29C 44/02; B29C 44/06

(52) U.S. Cl. CPC B29C 65/1412; B29L 2031/3008; B29C 44/06; B29C 44/027

(57) ABSTRACT

Provided are a resin molded component, a method for producing the resin molded component, and a method for producing a welded resin-molded article which ensure appropriate welding at a portion to be welded, without causing insufficient strength. A resin molded component 1 includes a body portion 10 and a rib 11 integrally molded with each other, the rib 11 protruding from the body portion 10 and configured to be infrared welded to a predetermined resin component 2, the resin molded component 1 having a foamed layer 12 formed at least in the body portion 10. A leading end portion of the rib 11 of the resin molded component 1 has a thinned remainder 11b which has been thinned relative to a root portion of the rib. For example, the rib width of the thinned remainder 11b of the rib 11 is smaller than the rib width of the root portion.

### TECHNICAL FIELD

The present invention relates to a resin molded component, a method for producing the resin molded component, and a method for producing a welded resin-molded article.

### BACKGROUND ART

Conventionally, welded resin-molded articles that are applied to air bag devices for vehicles are known (for example, Japanese Laid-Open Patent Publication No. 2002-86570). The welded resin-molded article described in Japanese Laid-Open Patent Publication No. 2002-86570 includes, as a resin molded component forming the welded resin-molded article: a frame-shaped retainer configured to have a case mounted thereto, the case having formed therein a housing space for housing an air bag; and an instrument panel configured to have the retainer mounted thereto. The retainer is provided with a rib protruding to the instrument panel side. The panel body of the instrument panel is provided with a rib protruding to the retainer side. The retainer and the instrument panel are integrated to each other by the ribs being welded to each other. An example of such a rib welding method is infrared welding in which: infrared radiation is applied to leading ends of ribs to melt the ribs; and then the melted ribs are subjected to pressure welding.

Meanwhile, some resin molded components are produced through foam molding. A resin molded component having foamability includes a foamed layer formed inside a solid layer and having a large number of voids formed therein. When a resin molded component including the foamed layer is to be subjected to infrared welding, if a foamed layer having a large number of voids therein is present at a welding target portion, a risk of inhibiting rigid integration, brought about by welding, of the resin molded component and another resin component exists. Even if welding is carried out, the voids in the foamed layer are present at the welded portion, and thus, a risk of causing insufficient welding strength exists.

The present invention has been made in view of such circumstances. An object of the present invention is to provide a resin molded component, a method for producing the resin molded component, and a method for producing 3 welded resin-molded article which ensure appropriate welding at a welded portion without causing insufficient strength of the welding.

The present invention is a resin molded component including: a body portion; and a rib protruding from the body portion and configured to be welded to a predetermined resin component through infrared welding, the body portion and the rib being molded integrally with each other, the resin molded component having a foamed layer formed at least in the body portion, wherein a leading end portion of the rib has a thinned remainder which has been thinned relative to a root portion of the rib.

According to this configuration, since the leading end portion of the rib has the thinned remainder which has been thinned relative to the root portion, foaming at the leading end side of the rib during foam molding is easily suppressed. Thus, when the resin molded component and the predetermined resin component are to be welded to each other through infrared welding, rigid integration of the resin molded component and the predetermined resin component is ensured and welding strength is improved. Therefore, appropriate welding at the portion welded to the predetermined resin component of the resin molded component is ensured without causing insufficient strength of the welding.

Furthermore, the present invention is a method for producing a welded resin-molded article, the method including: a melting step of melting the rib and the predetermined resin component by applying infrared radiation to a leading end of the rib of the resin molded component and the predetermined resin component according to claim 1 and; a joining step of joining the rib and the predetermined resin component by pressure welding the melted rib and the melted predetermined resin component to each other.

According to this configuration, the predetermined resin component and the resin molded component, which ensures, without causing insufficient strength, appropriate welding at the portion that is welded to the predetermined resin component, are more appropriately joined to each other through infrared welding.

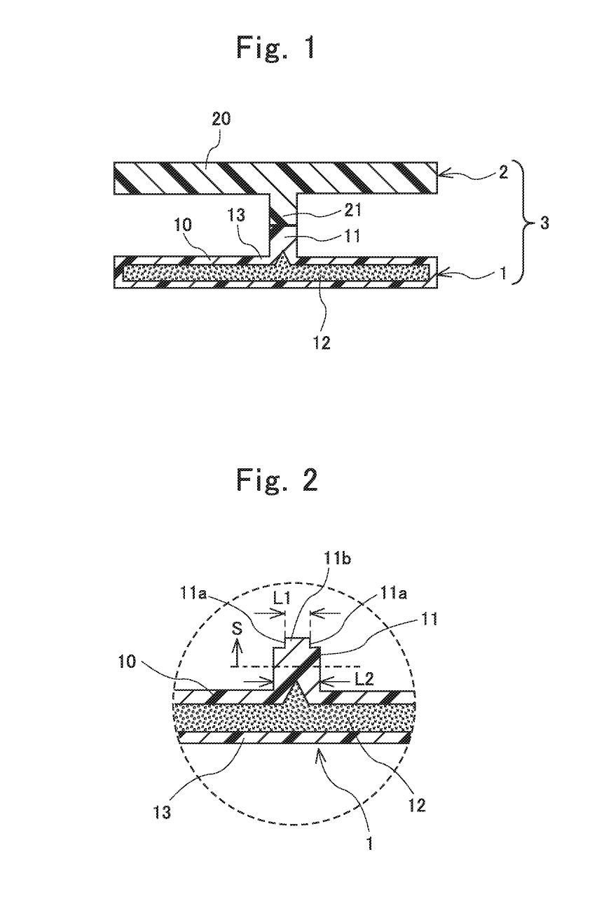

FIG. 1 is a cross-sectional view of a welded resin-molded article in which a resin molded component and a predetermined resin component are welded to each other according to one embodiment of the present invention;

FIG. 2 is an enlarged cross-sectional view of the resin molded component according to a first example of the present embodiment;

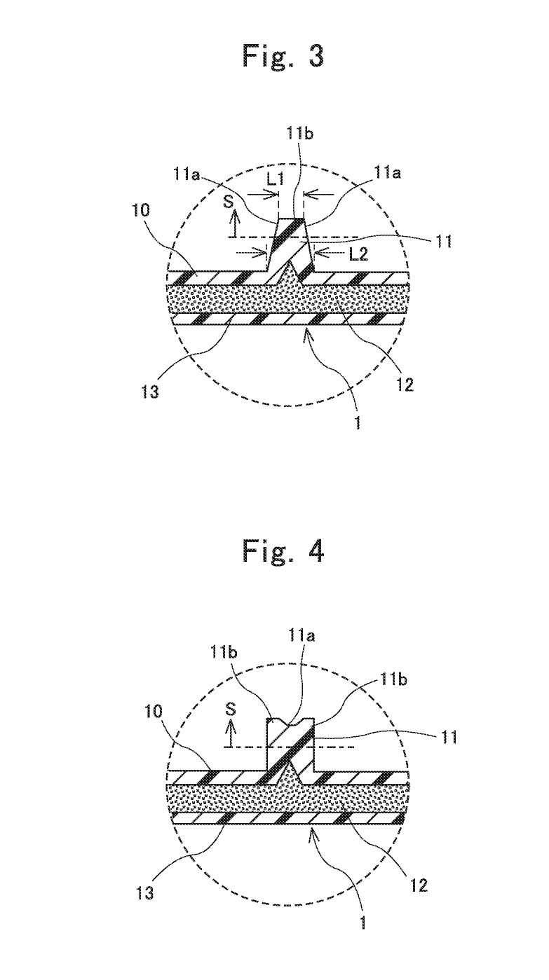

FIG. 3 is an enlarged cross-sectional view of the resin molded component according to a second example of the present embodiment;

FIG. 4 is an enlarged cross-sectional view of the resin molded component according to a third example of the present embodiment;

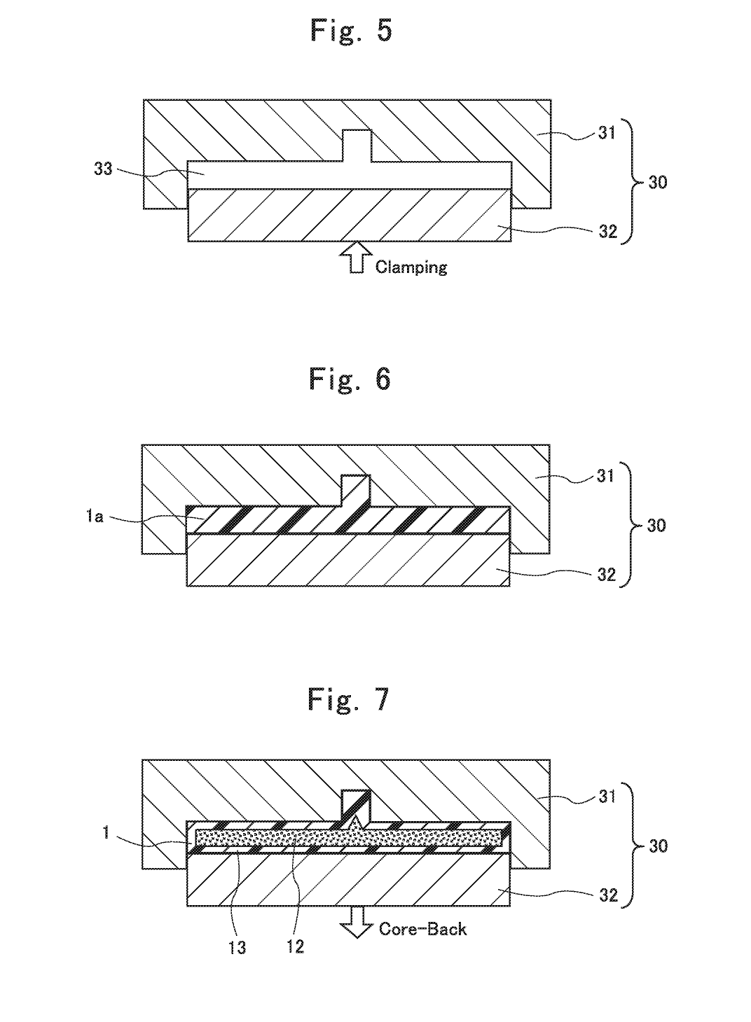

FIG. 5 is a cross-sectional view of a die for molding the resin molded component according to the present embodiment, before filling a resin;

FIG. 6 is a cross-sectional view of the die for molding the resin molded component according to the present embodiment, during filling of the resin;

FIG. 7 is a cross-sectional view of the die for molding the resin molded component according to the present embodiment, during a core-back operation performed on the die;

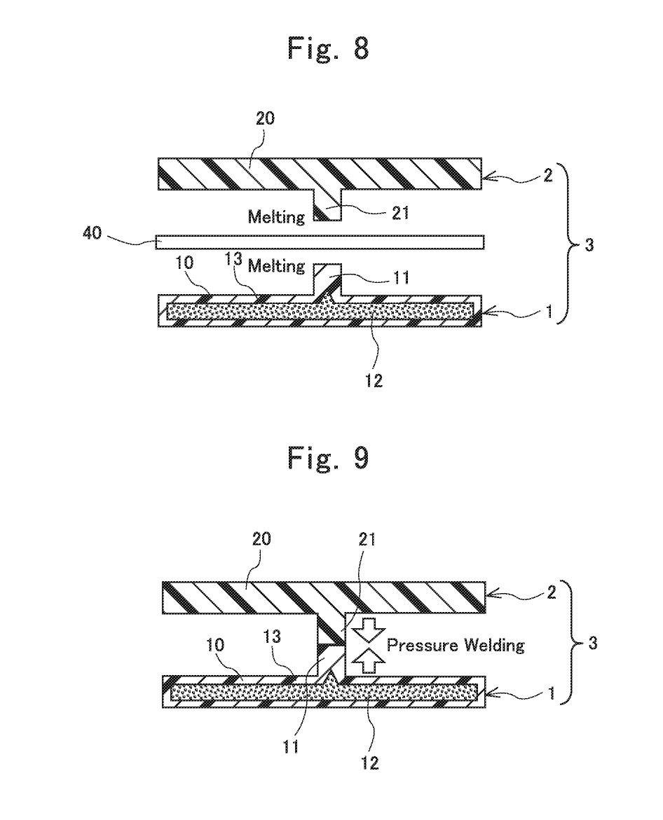

FIG. 8 is a cross-sectional view showing a state in which the leading end sides of the resin molded component and the predetermined resin component are melted by an infrared welding machine in order to weld the components with each other, according to the present embodiment;

FIG. 9 is a cross-sectional view showing a state in which the resin molded component, and the predetermined resin component are pressure welded to each other in order to weld the components with each other, according to the present embodiment;

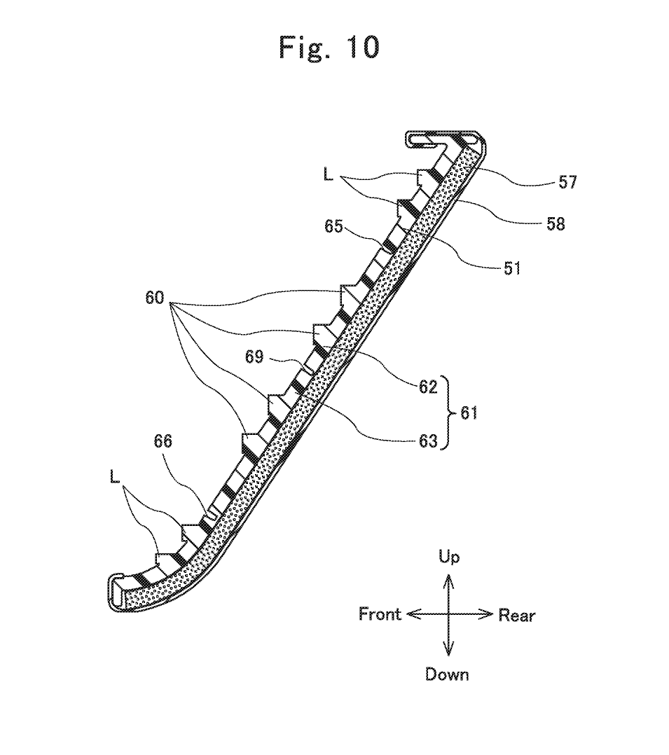

FIG. 10 is a cross-sectional view of an instrument lower panel of an air bag mounting interior trim which is a first application example of the resin molded component or the predetermined resin component according to the present embodiment;

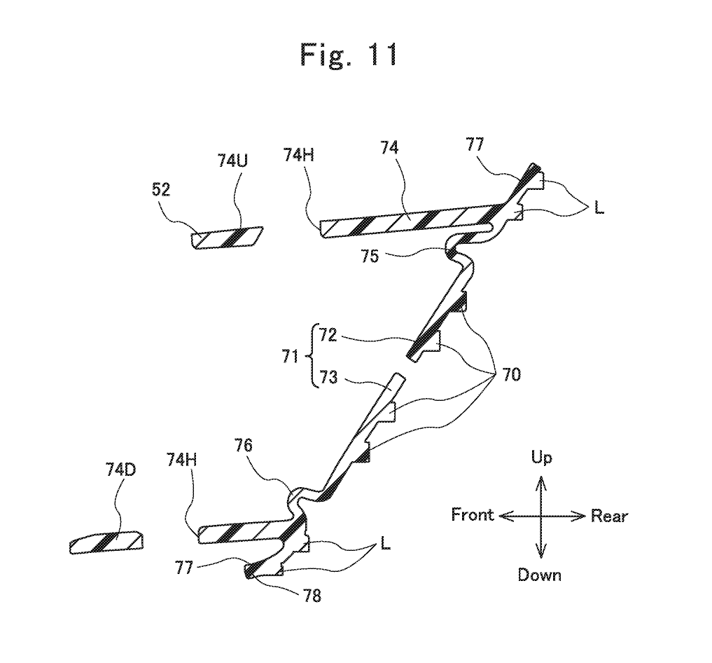

FIG. 11 is a longitudinal cross-sectional view of a retainer of the air bag mounting interior trim which is the first application example of the predetermined resin component or the resin molded component according to the present embodiment;

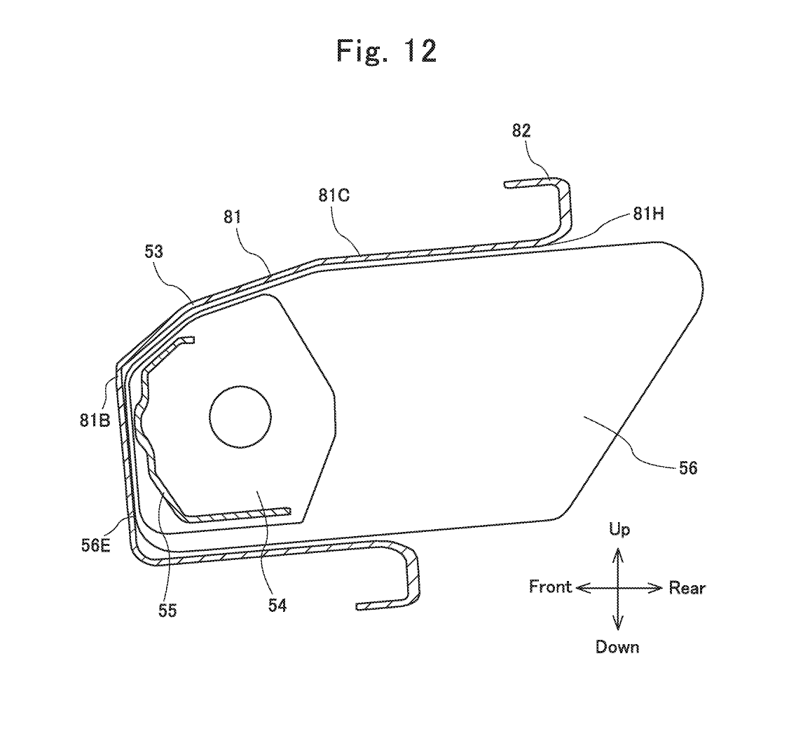

FIG. 12 is a longitudinal cross-sectional view of an air bag case to be mounted to the retainer shown in FIG. 11;

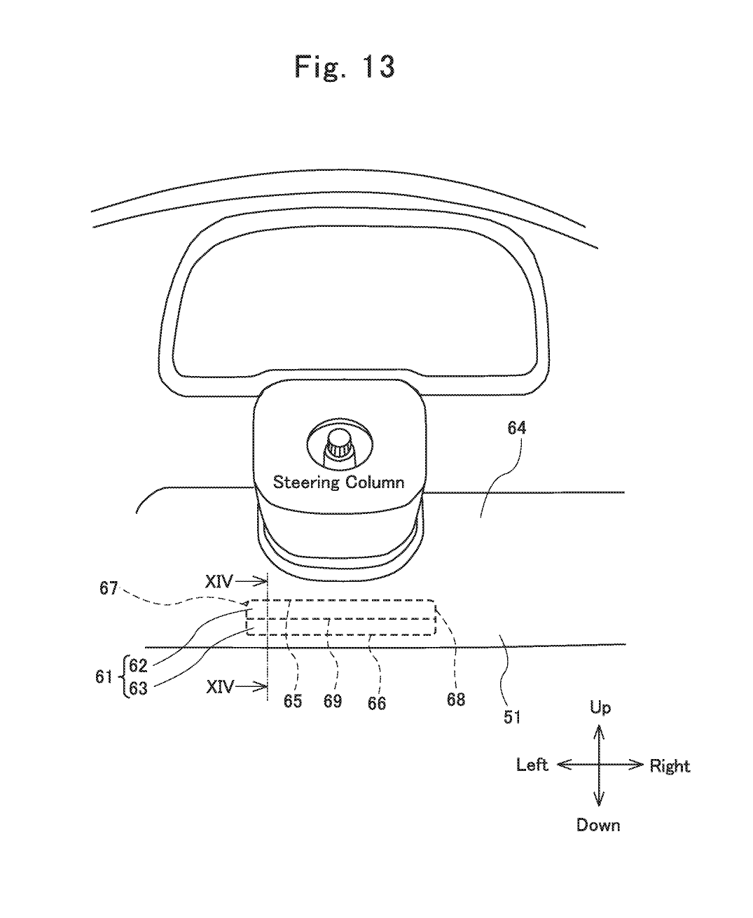

FIG. 13 is a schematic front view showing an assembled state of the air bag mounting interior trim according to the first application example, viewed from the vehicle rear side;

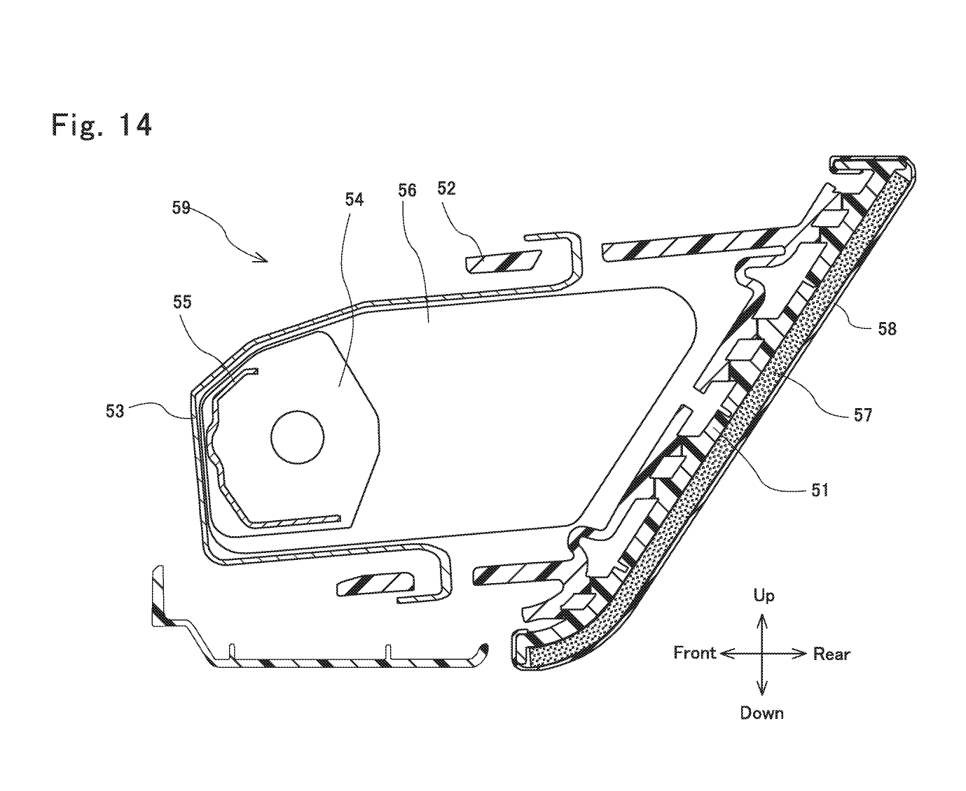

FIG. 14 is a cross-sectional view along the XIV-XIV line in FIG. 13 of the air bag mounting interior trim according to the first application example;

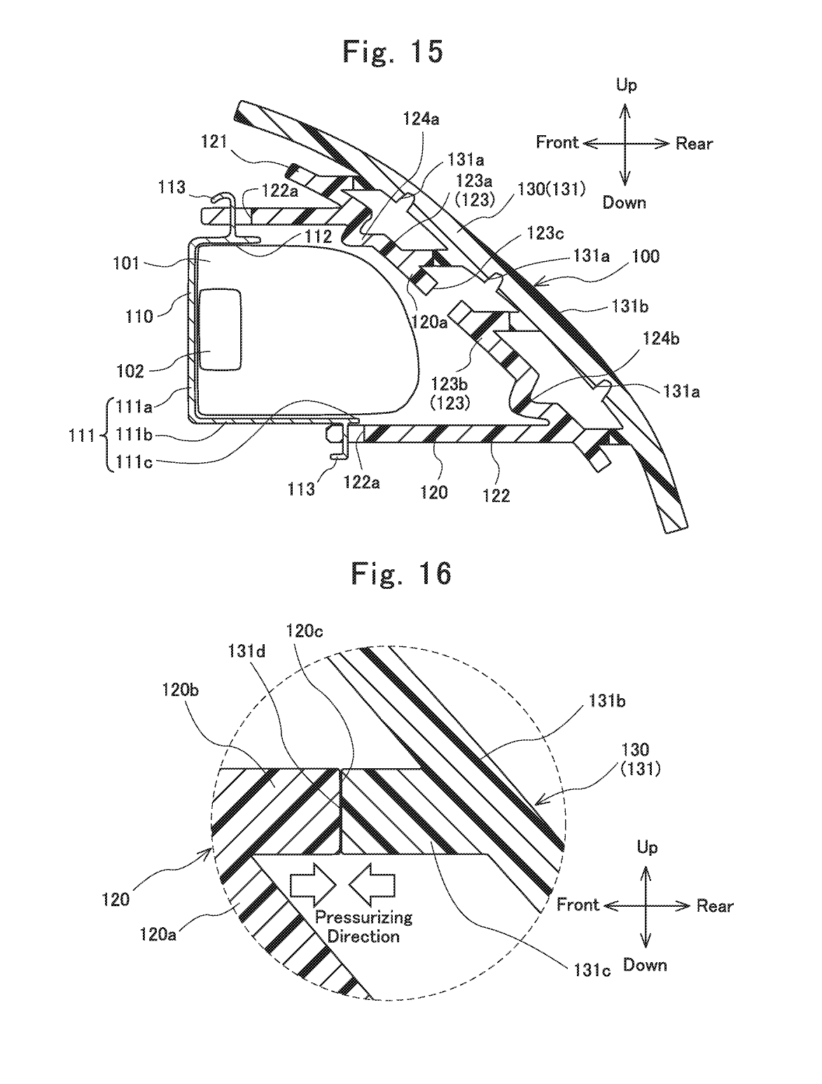

FIG. 15 is a cross-sectional view of the air bag mounting interior trim which is a second application example of a welded resin-molded article according to the present embodiment;

FIG. 16 is a cross-sectional view of a major part of the air bag mounting interior trim according to the second application example;

FIG. 17 is a cross-sectional view of the major part, immediately before being welded, of the air bag mounting interior trim according to a first modification of the second application example;

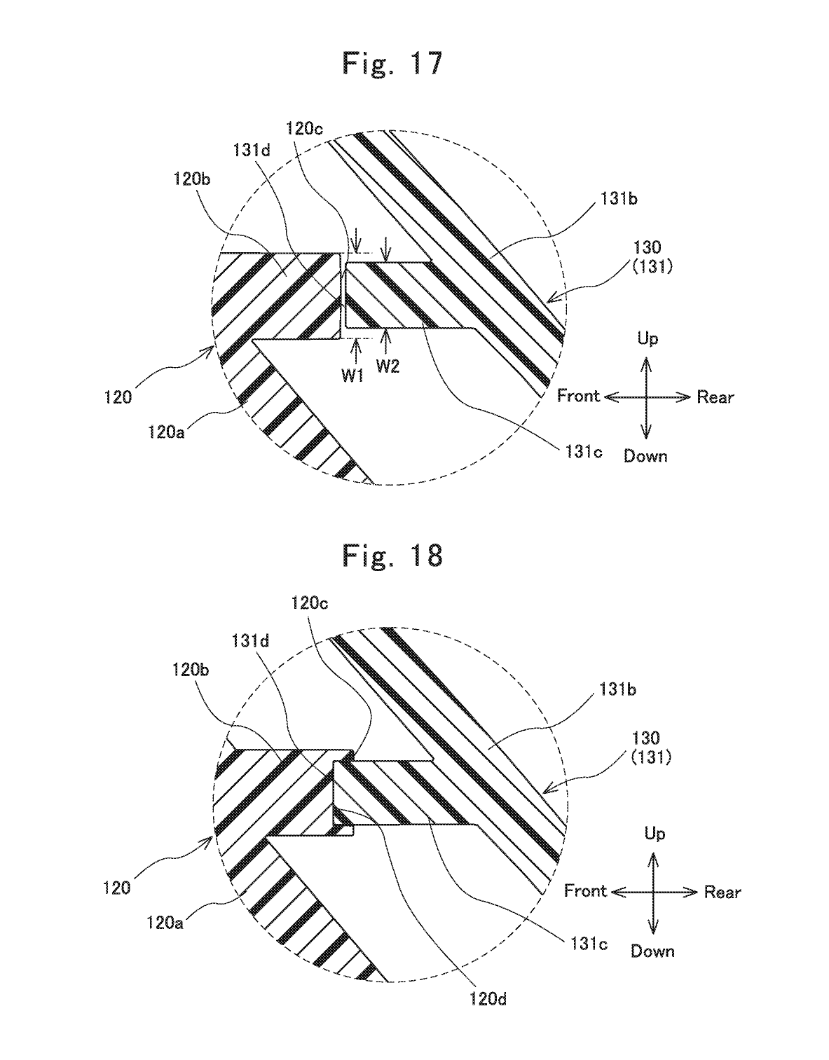

FIG. 18 is a cross-sectional view of the major part, at the time of completion of welding, of the air bag mounting interior trim shown in FIG. 17;

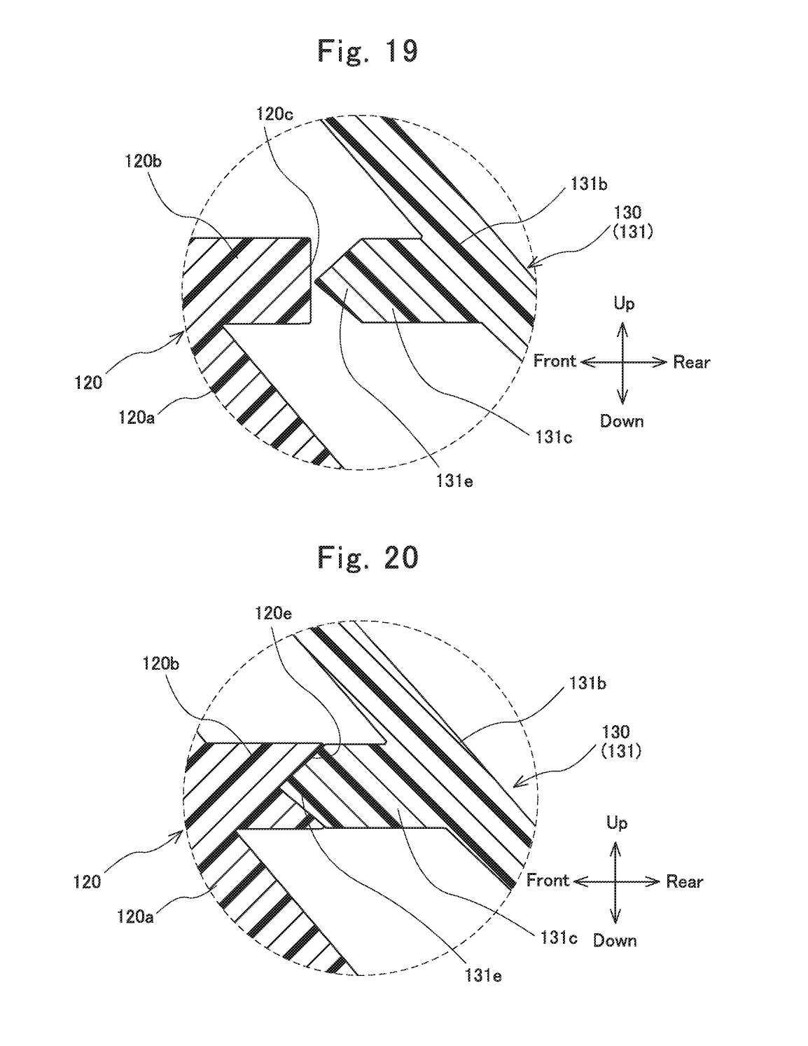

FIG. 19 is a cross-sectional view of the major part, immediately before being welded, of the air bag mounting interior trim according to a second modification of the second application example; and

FIG. 20 is a cross-sectional view of the major part, at the completion of welding, of the air bag mounting interior trim shown in FIG. 19.

Hereinafter, specific embodiments of a re sin molded component, a method for producing the resin molded component, and a method for producing a welded resin-molded article according to the present invention are described with reference to FIG. 1 to FIG. 20. In the embodiments below, “front”, “rear”, “left”, “right”, “up”, and “down (lower) ” directions used in description correspond to “front”, “rear”, “left”, “right”, “up”, and “down (lower)” directions for an occupant sitting in a vehicle while facing forward of the vehicle.

A resin molded component 1 of one embodiment is a component that is applied to a vehicle interior trim, for example. The resin molded component 1, for example, is a retainer which is a frame-shaped holding member configured to have a case housing an air bag mounted thereto, or an instrument panel or a door trim configured to have the retainer mounted thereto. The resin molded component 1 is a component obtained through resin molding, and the resin molded component 1, after being molded, is welded to a resin component 2 through infrared welding. The resin molded component 1 and the resin component 2 are the retainer and the instrument panel described above, for example. As shown in FIG. 1, the resin molded component 1 and the resin component 2 are welded to each other to be integrated, thereby forming a welded resin-molded article 3.

The resin molded component 1 is molded from a foamable resin material. Examples of the resin material for the resin molded component 1 include polypropylene (PP), and acrylonitrile-butadiene-styrene (ABS) resin. The resin molded component 1 is molded to have a solid layer formed at the surface side thereof and a foamed layer formed at the inside thereof by: filling a foamable resin material in a movable die; and after the filling, performing injection foam molding in which a core-back operation is performed on the die.

The resin molded component 1 has a body portion 10 and a rib 11. The body portion 10 is formed in a frame shape or a plate shape, and extends in a bar shape or a plate shape in a direction orthogonal to the thickness direction of the frame or the plate. The rib 11 is formed in a prism shape, a columnar shape, or a plate shape, and stands from the body portion 10. The rib 11 is a portion protruding from the body portion 10 and extending in the thickness direction of the body portion 10. The rib 11 is a portion configured to be welded, at the leading end side thereof, to the resin component 2 through infrared welding. The body portion 10 and the rib 11 are molded integrally with each other. The resin molded component 1 is molded into a state in which the body portion 10 and the rib 11 are integrated with each other through injection foam molding.

Preferably, in the rib 11, the width in a direction orthogonal to the thickness direction of the body portion 10, and the height in the thickness direction are each set to have a magnitude that realizes low foaming, in which foaming is suppressed, at the leading end portion of the rib 11 during formation of a foamed layer through injection foam molding. For example, the width of the rib 11 (specifically, a rib width L1 of a thinned remainder 11b described later) is preferably not greater than 1.5 mm.

“Low foaming” means foaming that is suppressed compared to foaming in other portions (i.e., foamed layer), and is a concept that includes no-foaming in which foaming does not occur at all. In the rib 11, a low-foamed portion in which low foaming is realized is a region having a porosity (or percentage of voids) per unit volume of less than 10%, and includes a region having a porosity of 0%. The low-foamed portion of the rib 11 extends over the entirety of a melted region in which the rib 11 is melted during infrared welding, and includes at least the entirety of the melted region.

As shown in FIG. 2, FIG. 3, and FIG. 4, the rib 11 of the resin molded component 1 is formed such that the volume per unit height in the rib-protruding direction in the leading end portion which is the portion to be welded to the resin component 2 is smaller than the volume per unit height in the rib-protruding direction in the root portion which is the portion connected to the body portion 10. The rib 11 has a thinned-out portion 11a which is a space generated as a result of the leading end portion being cut out. The leading end portion of the rib 11 has a thinned remainder 11b which has been thinned relative to the root portion because of the thinned-out portion 11a. Due to the thinned-out portion 11a and the thinned remainder 11b, the rib 11 has a stepped structure having a rectangular shape in cross section, an inclined structure having a triangular shape in cross section, or a holed structure having a recessed shape in cross section.

The stepped structure mentioned above is, as shown in FIG. 2, for example, a structure in which: the thinned-out portion 11a is provided at each of both sides in a direction orthogonal to the protruding direction of the rib 11 in the leading end portion; and the thinned remainder 11b is provided in such a manner as to be sandwiched by the two thinned-out portions 11a. The inclined structure mentioned above is, as shown in FIG. 3, for example, a structure in which: the rib width (i.e., the width in a direction orthogonal to the protruding direction of the rib 11) is gradually reduced from the root portion toward the leading end; the thinned-out portion 11a is provided at each of both sides in a direction orthogonal to the protruding direction of the rib 11 in the leading end portion; and the thinned remainder 11b is provided in such a manner as to be sandwiched by the two thinned-out portions 11a. Furthermore, the holed structure mentioned above is, as shown in FIG. 4, for example, a structure in which: the thinned-out portion 11a in the form of a groove is provided at the center in a direction orthogonal to the protruding direction of the rib 11 in the leading end portion; and the thinned remainder 11b is provided at each of both sides of the thinned-out portion 11a. With respect to the rib 11 having the stepped structure shown in FIG. 2 or the inclined structure shown in FIG. 3, the rib width L1 of the leading end portion (i.e., the thinned remainder 11b) is set so as to be smaller than a rib width L2 of the root portion.

The thinned-out portion 11a and the thinned remainder 11b of the rib 11 are set to have sizes that realize low foaming at the leading end portion of the rib 11 during formation of a foamed layer through injection foam molding. The rib 11 is molded such that the thinned-out portion 11a and the thinned remainder 11b are formed in the leading end portion through injection foam molding.

Molding of the resin molded component 1 is performed such that a foamed layer 12 and a solid layer 13 are provided. The foamed layer 12 is, for example, a region having an expansion ratio or a porosity per unit volume of not less than 10%, and is a layer that is mainly formed in the inside of the body portion 10 of the resin molded component 1. The solid layer 13 is a region other than the foamed layer 12, and is a layer that is mainly formed at the rib 11 and the surface of the body portion 10 of the resin molded component 1.

The resin component 2 is molded from a resin material. The resin component 2 may have foamability. Examples of the resin material for the resin component 2 include PP and ABS resin. The resin component 2, after being molded, is welded through infrared welding to the resin molded component 1 having foamability described above. The resin component 2 has a body portion 20 and a rib 21 protruding from the body portion 20, and may be welded, at the rib 21, to the rib 11 of the resin molded component 1 through infrared welding.

Next, a method for producing the resin molded component 1 is described.

First, as shown in FIG. 5, a movable die 30 which fits the shape of the resin molded component 1 having the body portion 10 and the rib 11 is prepared. The die 30 has a first die 31 and a second die 32. The first die 31 is an upper die which has a portion fitting the shape of the rib 11 and which is mainly for molding the face at the rib 11 side of the resin molded component 1. The second die 32 is a lower die mainly for molding the face at the side opposite to the rib 11 of the resin molded component 1.

The first die 31 and the second die 32 are disposed so as to be clamped into a state where a void (i.e., a cavity) 33 which fits a shape smaller than a desired shape of the resin molded component 1 is formed. The clamping arrangement of the first die 31 and the second die 32 is maintained until molding of the resin molded component 1 is started (specifically, until the start of a core-back operation described later). The second die 32 is capable of moving (core-back) in a direction away from the first die 31 (downward in FIG. 5). The second die 32 is subjected to the core-back operation in order to form the foamed layer 12 inside the resin molded component 1 after the resin material is filled in the die 30.

After the die 30 composed of the first die 31 and the second die 32 having the above-described void 33 formed therebetween has been prepared, a foamable resin material 1a is filled in the void 33 in the die 30 as shown in FIG. 6. Then, as shown in FIG. 7, after the resin has been filled in the die 30, a core-back operation is performed on the second die 32 in a direction away from the first die 31. The longer the holding time from the filling of the resin material 1a to the core-back operation on the second die 32 is, the greater the thickness of the solid layer 13 becomes. Thus, a long holding time is advantageous in terms of suppressing foaming (i.e., realizing low foaming) in the rib 11, but if the holding time is too long, low foaming reaches the body portion 10 of the resin molded component 1. Therefore, the holding time described above is set such that low foaming reaches at least the leading end portion of the rib 11 but does not reach the body portion 10. The core-back amount of the second die 32 is set to have a magnitude at which foaming at least at the leading end portion of the rib 11 is suppressed.

When the core-back operation has been performed on the second die 32, the resin filled in the void 33 is foamed. When the resin is foamed, the foamed layer 12 is formed in an inner portion away from the die 30 of the resin molded component 1. At this time, at the surface side that is in contact with or relatively close to the die 30 of the resin molded component 1, the solid layer 13 in which foaming is suppressed due to cooling by the first die 31 and the second die 32 is formed.

In this manner, while the foamed layer 12 is formed inside the resin molded component 1, the solid layer 13 in which foaming is suppressed compared to foaming in the foamed layer 12 is formed at the rib 11 and the surface side of the resin molded component 1. In particular, the leading end portion of the rib 11 has the thinned-out portion 11a and the thinned remainder 11b which has been thinned relative to the root portion because of the thinned-out portion 11a. In the structure where the leading end portion of the rib 11 has been thinned relative to the root portion, when compared with a structure without the thinning, the contact with the die 30 is ensured to the depth (root side) of the rib 11 and the contact area with the die 30 at the leading end portion of the rib 11 is increased. Therefore, foaming at the leading end portion of the rib 11 is easily suppressed, the foamed layer 12 is prevented from reaching the leading end portion of the rib 11, and the leading end portion of the rib 11 is made as a low-foamed portion which is the solid layer 13. Thus, the resin molded component 1 in which foaming is reliably suppressed in the entirety of the leading end portion of the rib 11 is produced.

Next, a method for producing the welded resin-molded article 3 by welding the resin molded component 1 and the resin component 2 to each other is described.

First, the resin molded component 1 produced as described above is prepared, and the resin component 2 to which the resin molded component 1 is to be welded is prepared. Next, as shown in FIG. 8, the resin molded component 1 and the resin component 2 are disposed such that a gap is formed between the ribs 11 and 21, and an infrared welding machine 40 is inserted in the gap. The infrared welding machine 40 is a device which applies infrared radiation to a welding target resin, thereby melting the resin.

Then, the leading ends of the ribs 11 and 21 of the resin molded component 1 and the resin component 2 are melted by raising the temperatures of the leading ends of the ribs 11 and 21 to a predetermined temperature by means of the infrared welding machine 40. In particular, melting of the rib 11 is performed such that a melted region S is within the range of the low-foamed portion realized as the solid layer 13 of the rib 11 and does not reach the foamed layer 12. Next, by use of a jig, the resin molded component 1 and the resin component 2 each having the melted leading end are moved relative to each other in a direction (up-down direction shown in FIG. 9) in which the resin molded component 1 and the resin component 2 come closer to each other, whereby the leading end portions of the ribs 11 and 21 are brought into contact with each other and pressure-welded as shown in FIG. 9. By this technique, the welded resin-molded article 3 having the resin molded component 1 and the resin component 2 welded to each other through infrared welding is produced.

According to the structure in which the foamed layer 12 is not formed at the leading end portion as the welding target portion of the rib 11 of the resin molded component 1 and foaming at the leading end portion is suppressed, the melted region S of the rib 11 during infrared welding is within the range of the low-foamed portion realized as the solid layer 13 of the rib 11, and does not reach the foamed layer 12. Thus, compared with a structure in which the foamed layer 12 is formed so as to extend into the leading end portion of the rib 11, when the resin molded component 1 and the resin component 2 are to be welded to each other through infrared welding, rigid integration of the components 1 and 2 is ensured and welding strength is improved. Therefore, according to the resin molded component 1, appropriate welding at the leading end side which is the portion that is welded to the resin component 2 is ensured without causing insufficient strength of the welding. Conversely, the resin molded component 1 which ensures, without causing insufficient strength, appropriate welding at the leading end side which is the port ion that is welded to the resin component 2 is produced.

Moreover, after the resin molded component 1 is produced as described above, the resin molded component 3 and the resin component 2 produced separately from the resin molded component 1 are welded to each other through infrared welding. Therefore, joining of the resin molded component 1 and the resin component 2 is appropriately performed, and the welding strength after the joining is ensured.

It should be noted that, in the embodiment described above, the resin component 2 corresponds to “predetermined resin component” described in the claims.

Meanwhile, in the embodiment described above, the thinned-out portion 11a of the rib 11 is provided at both sides in a direction orthogonal to the protruding direction of the rib 11 as shown in FIG. 2 and FIG. 3, or is provided in a recessed manner at only one position, i.e., at the center, in a direction orthogonal to the protruding direction of the rib 11 in the leading end portion of the rib 11 as shown in FIG. 4. However, the present invention is not limited thereto. The thinned-out portion 11a may be provided at not less than three discrete positions in a direction orthogonal to the protruding direction of the rib 11.

Hereinafter, application examples of the resin molded component 1, the method for producing the resin molded component 1, and the method for producing the welded resin-molded article 3 according to the present embodiment are described.

### First Application Example

A first application example is an example in which the resin molded component 1, the resin component 2, and the welded resin-molded article 3 are applied to an interior trim for mounting an air bag (hereinafter, air bag mounting interior trim). The welded resin-molded article 3 is an interior product applied to a knee air bag device 59 for vehicles. The knee air bag device 59 for vehicles has an instrument lower panel base member 51 and a retainer 52 as the resin molded component 1 and the resin component 2. The resin molded component 1 may be either the instrument lower panel base member 51 or the retainer 52, and the resin component 2 is the other of the instrument lower panel base member 51 or the retainer 52. As shown in FIG. 14, the knee air bag device 59 for vehicles is provided such that the retainer 52 is integrated with the instrument lower panel base member 51 provided at a front portion in the compartment.

The instrument lower panel base member 51 is mounted so as to be inclined from the rear and upper side of the vehicle to the front and lower side of the vehicle.

The retainer 52 is joined to the front side of the inclined instrument lower panel base member 51.

### Components

### Instrument Lower Panel

As shown in FIG. 10 and FIG. 13, an instrument lower panel includes: the instrument lower panel base member 51; and a cushion layer 57 and a skin 58 which are joined ac the rear side of the instrument lower panel base member 51. The instrument lower panel base member 51 includes: an opening portion 61 composed of two doors 62 and 63; and an outer peripheral portion 64 surrounding the opening portion 61. The two doors 62 and 63 are defined by tear lines 65, 66, 67, 68, and 69 provided in a shape of two rectangles arranged alongside each other and at a position corresponding to the borders of flaps 72 and 73 of a lid 71 facing rearward of the retainer 52.

The instrument lower panel may be composed only of the instrument lower panel base member 51, without the cushion layer 57 and the skin 58.

### Retainer

As shown in FIG. 11, the retainer 52 includes: the lid 71 provided in parallel to the back surface of the opening portion 61; a frame portion 74 protruding forward; and a flange portion 77 extending to the outer peripheral side of the frame portion 74 and provided in parallel to the instrument lower panel.

The lid 71 is composed of the upper flap 72 and the lower flap 73, and the flange portion 77 is like a frame formed around the lid 71. The upper flap 72 is coupled through a hinge portion 75 to a rear end of the frame portion 74. Similarly, the lower flap 73 is coupled through a hinge portion 76 to a rear end of the frame portion 74.

Each of the hinge portions 75 and 76 is formed such that the cross-sectional shape thereof is in a “U” shape that is open substantially rearward. The hinge portion 75, 76 is curved toward the opened side thereof. In addition, the thickness, the material, the shape, and the like of the hinge portion 75, 76 are set such that the deployment amount of the flap 72, 73 deploying toward the compartment is restricted in a certain range.

The two flaps 72 and 73 of the lid 71 and the flange portion 77 are in parallel to the instrument lower panel base member 51, and form a fixing plate portion 78 of the retainer 52, facing the front side of the instrument lower panel base member 51.

The borders of the two flaps 72 and 73 correspond to the tear lines 65, 66, 67, 68, and 69, and thus, the flaps 72 and 73 are formed in substantially the same sizes and shapes as the upper door 62 and the lower door 63, respectively.

The frame portion 74 is formed in a tubular shape so as to extend from an inner side portion of the flange portion 77 toward the front in 3 substantially horizontal direction. Of the frame portion 74, a pair of side wall portions 74U and 74D opposed to each other in the up-down direction of the vehicle have formed therein engagement holes 74H penetrating the side wall portions 74U and 74D in the thickness direction thereof.

### Weld Ribs

Between the front side of the instrument lower panel and the rear side of the fixing plate portion 78 (at least between the front side of the opening portion 61 and the rear side of the lid 71), first weld ribs 60 and second weld ribs 70 are provided. Each of the first weld ribs 60 extends in the vehicle width direction, protrudes forward from the front side of the opening portion 61, and has an end thereof formed as a perpendicular plane extending in a direction orthogonal to the protruding direction thereof. Each of the second weld ribs 70 extends in the vehicle width direction, protrudes rearward from the rear side of the lid 71, has an end thereof formed as a perpendicular plane extending in a direction orthogonal to the protruding direction thereof, and is configured to be welded to a corresponding one of the first weld ribs 60.

### Case

A case 53 is provided to the front side of the lid 71 of the retainer 52, and is fixed to the vehicle body through a fixing component, which is not shown. As shown in FIG. 12, the case 53 has a body portion 81 formed in a box shape. The body portion 81 has an opening 81H at the door 62, 63 side, and has a bottom portion 81B at the side opposite to the opening 81H.

The body portion 81 is disposed inside the frame portion 74. A peripheral wall portion 81C is formed in the body portion 81. At ends on the opening 81H side of a pair of side wall portions, of the peripheral wall portion 81C, opposed to each other in the up-down direction of the vehicle, engagement portions 82 are formed, respectively. At the time of assembly, the engagement portions 82 are engaged with the corresponding engagement holes 74H, respectively.

### Inflator

An inflator 54 is fixed in the case 53 by means of a fixing member 55. When a signal outputted from a control device, which is not shown, has been inputted, the inflator 54 supplies gas into an air bag 56 such that the air bag 56 is inflated to be deployed.

### Air Bag

The air bag 56 is housed in a folded state inside the case 53, and a proximal portion 56E of the air bag 56 is fixed to the bottom portion 81B.

### Welding and Assembly

The cushion layer 57 and the skin 58 are sequentially mounted to corresponding positions at the rear side of the instrument lower panel base member 51, to form an instrument lower panel.

The ends of the first weld ribs 60 and the ends of the second weld ribs 70 between the front side of the instrument lower panel base member 51 and the rear side of the fixing plate portion 78 of the retainer 52 are correspondingly welded to each other through infrared welding, thereby reliably integrating the retainer 52 and the instrument lower panel base member 51 to each other, and join the flap 72, 73 and the corresponding door 62, 63 together, in particular.

At this time, the instrument lower panel is fixed to a fixture, and the flaps 72 and 73 are both pressed against the instrument lower panel base member 51 in a direction along the frame portion 74 (i.e., substantially horizontal front-rear direction) by means of a pressing jig disposed in the frame portion 74 of the retainer 52. At the same time, weld ribs L disposed around the first weld ribs 60 and weld ribs L disposed around the second weld ribs 70 are also welded to each other.

At this time, each of the ribs 60, 70, and L extends in the pressing direction, i.e., a substantially horizontal front-rear direction, and the end thereof is formed as a perpendicular plane extending in a direction orthogonal to the pressing direction. Thus, each of the ribs 60, 70, and L is reliably welded.

Then, a fixing device, which is not shown, is mounted to the case 53 having fixed thereto the inflator 54, the fixing member 55, and the air bag 56 in a folded state. Then, the engagement portions 82 are engaged with the engagement holes 74H of the retainer 52, whereby the knee air bag device 59 is completed.

### Operation and Effect

Next, operation and effect of the first application example described above are described.

According to the knee air bag device 59, in order to restrain an occupant when necessary, if the control device outputs a signal to the inflator 54, the inflator 54 supplies gas to the air bag 56, and upon reception of the supply of the gas, the air bag 56 begins to be inflated to be deployed toward the inside of the compartment. Accordingly, the flaps 72 and 73 of the retainer 52 are deployed, and at the same time, receive pressure from the air bag 56 at the back surfaces of the flaps 72 and 73. Thus, the flaps 72 and 73 rotate around the hinge portions 75 and 76 through elastic deformation of the hinge portions 75 and 76, to be opened toward the compartment side.

At the same time, the two doors 62 and 63, of the opening portion 61, welded to the flaps 72 and 73 tear open from the tear lines 65, 66, 67, 68, and 69, to be deployed together with the flaps 72 and 73, whereby the air bag 56 is smoothly deployed into the compartment.

In the application example described above, the air bag mounting interior trim is applied to the knee air bag device 59 for vehicles. However, the present invention is not limited thereto. The air bag mounting interior trim may be applied to an air bag device for vehicles, the air bag device being disposed to the front side with respect to the upper body of a target occupant. Alternatively, the air bag mounting interior trim may be applied to an air bag device for vehicles, the air bag device being disposed to a lateral side with respect to the target occupant.

### Second Application Example

A second application example is an example in which the resin molded component 1, the resin component 2, and the welded resin-molded article 3 are applied to an air bag mounting interior trim. The welded resin-molded article 3 is an air bag mounting interior trim 100 applied to an air bag device for vehicles. The air bag mounting interior trim 100 is a panel member holding an air bag 101, the panel member being configured to tear open at the time of deployment of the air bag 101. As shown in FIG. 15, the air bag mounting interior trim 100 includes: a case 110; and a retainer 120 and an instrument panel 130 as the resin molded component 1 and the resin component 2. The resin molded component 1 may be either the retainer 120 or the instrument panel 130, and the resin component 2 is the other of the retainer 120 or the instrument panel 130.

The air bag 101 is a bag-shaped sheet member for protecting an occupant siting on a seat of a vehicle. The air bag 101 is disposed to the front with respect to a target occupant. Gas generated by an inflator 102 at the time of deployment is supplied into the air bag 101. An external control device (not shown) is electrically connected to the inflator 102. When a deployment signal for causing the air bag 101 to be inflated to be deployed is inputted from the control device, the inflator 102 generates high pressure gas and supplies the high pressure gas into the air bag 101. By being supplied with the gas from the inflator 102, the air bag 101 is inflated to be deployed rearward, thereby protecting the occupant.

The case 110 is a housing member housing the air bag 101 before being inflated to be deployed. The case 110 is formed in a box shape so as to house the folded air bag 101. The case 110 has a body portion 111 composed of a bottom wall 111a, a side wall 111b, and an opening 111c.

The side wall 111b is a tube portion formed in a tubular shape. One end side of the side wall 111b is closed by the bottom wall 111a. The bottom wall 111a and the side wall 111b form a housing space 112 in which all or part of the folded air bag 101 is housed. The air bag 101 is housed in the housing space 112 in a state where a proximal portion of the air bag 101 is fixed to the bottom wall 111a of the body portion 111 of the case 110. The inflator 102 is fixed to the case 110 through a fixing component.

The opening 111c is provided at the other end side of the side wall 111b, and is opposed to the bottom wall 111a, at the side at which the air bag 101 is to be deployed. The case 110 is disposed such that, in the body portion 111, the opening 111c is located to the side where the occupant of the vehicle sits (specifically, rear side), i.e., such that the housed air bag 101 is deployed through the opening 111c to the inner side of the compartment.

The case 110 further includes an engagement portion 113. The engagement portion 113 is formed integrally with the body portion 111. The engagement portion 113 is a claw portion provided at an end portion at the opening 111c side of the side wall 111b of the body portion 111, so as to protrude to the radially outer side of the side wall 111b. The engagement portion 113 is provided at a plurality of positions (for example, one at each of an upper position and a lower position) in the body portion 111. Each engagement portion 113 is a portion for mounting and fixing the case 110 to the retainer 120, by being engaged with the retainer 120.

The retainer 120 is a holding member holding the case 110 housing the air bag 101. The retainer 120 is a member for mounting the air bag 101 to the back surface side, opposite to the surface at the compartment inner side (i.e., rear side), of the instrument panel 130. The retainer 120 is formed from resin. Examples of the material of the retainer 120 include polyolefin-based soft resin (TPO) and super olefin polymer (TSOP). The retainer 120 has a structure in which a base portion 121, a tube portion 122, and a lid portion 123 are integrally formed through injection molding or the like.

The base portion 121 is a fixation portion to be joined and fixed to the back surface of the instrument panel 130. The base portion 121 is formed in a frame shape. The technique of fixing the base portion 121 and the instrument panel 130 to each other is described later in detail. The tube portion 122 is formed in a frame shape so as to extend forward from the back surface (i.e., front face) of the base portion 121, and holds the case 110 at the inner peripheral side thereof. The lid portion 123 is formed so as to cover the inside of the frame of the base portion 121 having the frame shape, and rotates so as to open by being pressed at the time of the air bag 101 being inflated to be deployed.

The peripheral wall of the tube portion 122 includes an engagement hole 122a formed therein. The engagement hole 122a is provided by the number that corresponds to the number of the engagement portions 113 of the case 110. The engagement portions 113 of the case 110 are engaged with the engagement holes 122a, respectively. By the engagement portions 113 being engaged with the engagement holes 122a of the tube portion 122, the case 110 is held by the retainer 120.

The lid portion 123 has two flaps 123a and 123b. The flaps 123a and 123b are each a plate-like member formed in a rectangular shape, for example, and are disposed such that an opening 123c is formed between the flap 123a and the flap 123b. The upper edge of the flap 123a is coupled to an upper frame portion of the base portion 121 through a hinge portion 124a. The lower edge of the flap 123b is coupled to a lower frame portion of the base portion 121 through a hinge portion 124b. The opening 123c is a horizontally extending slit hole portion. The lid portion 123 is not limited to a lid portion of a double-swinging type, and maybe a lid portion of a single swinging type having a single flap. Alternatively, the number of the flaps of the lid portion 123 may be 3 or greater.

The hinge portion 124a couples the flap 123a to the inner edge of the base portion 121 in a state where the flap 123a is rotatable about the upper edge of the flap 123. The hinge portion 124b couples the flap 123b to the inner edge of the base portion 121 in a state where the flap 123b is rotatable about the lower edge of the flap 123b. Each of the hinge portions 124a and 124b extends in a strip shape along in the left-right direction, and is formed in a U-shape in cross section. The hinge portions 124a and 124b are each disposed in a state where the open side of the U-shaped groove in cross section faces rearward, such that the flaps 123a and 123b are less likely to rotate toward the front side under pressing force applied from the rear side toward the front side, and such that the flaps 123a and 123b easily rotate toward the rear side under pressing force applied from the front side toward the rear side. The hinge portions 124a and 124b are each formed from elastomer, for example.

In the structure of the lid portion 123 described above, when the air bag 101 housed in the case 110 held by the retainer 120 is inflated to be deployed, the flap 123a is pressed from the front side toward the rear side to be rotated about the upper edge of the flap 123a, and the flap 123b is pressed from the front side toward the rear side to be rotated about the lower edge of the flap 123b, as a result of the inflation and deployment of the air bag 101. Due to the rotations of the flaps 123a and 123b, the lid portion 123 opens wide from the opening 123c at the center thereof.

That is, the retainer 120 has the lid portion 123 and the base portion 121 defining the side, at which the air bag 101 is to be deployed, of the housing space 112 of the case 110 housing the air bag 101, and the retainer 120 is formed such that a part (specifically, opening 123c) of the lid portion 123 opens.

The instrument panel 130 is a plate-like member to be used as an interior material for the compartment (cabin) of a vehicle. The instrument panel 130 is provided at a position opposed to the upper body of an occupant sitting at a passenger seat, for example. The retainer 120 is fixed to the back surface (i.e., front face) of the instrument panel 130. The instrument panel 130 has a panel base member 131. The instrument panel 130 is not limited to an instrument panel composed only of the panel base member 131, and may include a cushioning member and a skin member.

The panel base member 131 is a plate-like member formed from resin. Examples of the material of the panel base member 131 include polyolefin-based soft resin (TPO) and super olefin polymer (TSOP). The material of the panel base member 131 may be different from the material of the retainer 120. The panel base member 131 is curved so as to protrude toward the inner side of the compartment, and is formed so as to be inclined with respect to the horizontal direction from an upper front portion thereof to a lower rear portion thereof. The retainer 120 is curved in accordance with the curved shape of the panel base member 131, and is formed so as to be inclined from an upper front portion thereof to a lower rear portion thereof. The panel base member 131 is disposed so as to be opposed to the base portion 121 and the lid portion 123 of the retainer 120, at the side where the air bag 101 is to be deployed.

The panel base member 131 has tear lines 131a formed therein. The tear lines 131a are provided at positions corresponding to peripheral edges of the flaps 123a and 123b of the lid portion 123 of the retainer 120 fixed to the panel base member 131. The tear lines 131a allow the panel base member 131 to easily tear open in the form of two doors at the time of inflation and deployment of the air bag 101.

The panel base member 131 is welded to the base portion 121 and the lid portion 123 of the retainer 120, thereby being joined and fixed to the retainer 120. Specifically, the retainer 120 and the panel base member 131 of the instrument panel 130 are welded to each other through infrared welding. Infrared welding is performed by use of an infrared welding machine (not shown). The infrared welding is a type of welding in which: infrared radiation is applied from an infrared welding machine to the retainer 120 and the panel base member 131 to transfer heat in a non-contact manner, thereby plasticizing the retainer 120 and the panel base member 131, and then, the melted retainer 120 and the melted panel base member 131 are resolidified in a pressurized state to be joined together.

The base portion 121 and the lid portion 123 of the retainer 120 are curved so as to protrude toward the inner side of the compartment. The base portion 121 and the lid portion 123 of the retainer 120 have an inclined face 120a inclined with respect to the horizontal direction and extending from an upper front portion thereof to a lower rear portion thereof. The inclination angle of the inclined face 120a may be varied depending on the portion of the retainer 120 and in accordance with the curved degree thereof. The base portion 121 and the lid portion 123 of the retainer 120 are formed so as to have substantially the same thickness throughout the entire region thereof. The inclined face 120a is formed such that the normal at the rear face side (surface side) thereof is directed rearward and obliquely upward and the normal at the front face side (back surface side) thereof is directed forward and obliquely downward.

The retainer 120 and the panel base member 131 of the instrument panel 130 are moved relative to each other in a substantially horizontal direction at the time of assembly for welding, and are pressurized in a state where the retainer 120 and the panel base member 131 are in contact with each other. The pressurizing direction at the time of assembly of the retainer 120 and the panel base member 131 is a substantially horizontal direction. The retainer 120 and the panel base member 131 are welded to each other in a state where the retainer 120 and the panel base member 131 are pressurized in the substantially horizontal direction. The inclined face 120a of the retainer 120 described above is inclined with respect to the pressurizing direction realized at the time of assembly of the retainer 120 and the panel base member 131.

As shown in FIG. 16, the retainer 120 includes ribs 120b. The ribs 120b are provided at the rear face side (i.e., surface side) of the base portion 121 and the lid portion 123 of the retainer 120. The ribs 120b linearly protrude from the base portion 121 and the lid portion 123 toward the panel base member 131 side along the pressurizing direction described above, and extend along the vehicle width direction in the protruding state. The ribs 120b are provided in a multiple number, and are disposed substantially evenly throughout the entire region of the base portion 121 and the lid portion 123. The ribs 120b include ribs that protrude from the inclined face 120a of the base portion 121 and the lid portion 123 (FIG. 15 shows such ribs at four positions), and ribs that protrude from a face not being the inclined face 120a. Each rib 120b has a weld end face 120c of which normal extends in the pressurizing direction described above. The weld end face 120c is a face extending in a direction perpendicular to the pressurizing direction described above.

The panel base member 131 is curved so as to protrude toward the inner side of the compartment. The panel base member 131 has an inclined face 131b inclined with respect to the horizontal direction and extending from an upper front portion thereof to a lower rear portion thereof. The inclination angle of the inclined face 131b may be varied depending on the portion of the panel base member 131 and in accordance with the curved degree thereof. The panel base member 131 is formed so as to have substantially the same thickness throughout the entire region thereof. The inclined face 131b is formed such that the normal at the rear face side (surface side) thereof is directed rearward and obliquely upward and the normal at the front face side (back surface side) thereof is directed forward and obliquely downward. The inclined face 131b is inclined with respect to the pressurizing direction realized at the time of assembly of the retainer 120 and the panel base member 131.

As shown in FIG. 16, the panel base member 131 includes ribs 131c. The ribs 131c are provided at the front face side (i.e., back surface side) of the panel base member 131. The ribs 131c linearly protrude from the panel base member 131 toward the retainer 120 side along the pressurizing direction described above, and extend along the vehicle width direction in the protruding state. The ribs 131c are provided in a multiple number so as to realize one-to-one correspondence with the ribs 120b of the retainer 120, and are disposed substantially evenly throughout the entire region of the panel base member 131. The ribs 131c includes ribs that protrude from the inclined face 131b (FIG. 15 shows such ribs at four positions), and ribs that protrude from a face not being the inclined face 131b. Each rib 131c has a weld end face 131d of which normal extends in the pressurizing direction described above. The weld end face 131d is a face extending in a direction perpendicular to the pressurizing direction described above.

The weld end face 120c of each rib 120b of the retainer 120 and the weld end face 131d of a corresponding rib 131c of the panel base member 131 of the instrument panel 130 face each other in a parallel manner. The direction in which the weld end face 120c and the weld end face 131d face each other is aligned with the pressurizing direction in which the retainer 120 and the panel base member 131 are moved relative to each other at the time of assembly thereof, to be brought into contact with each other and pressurized.

A method for producing the air bag mounting interior trim 100 of the present application example is described.

First, the retainer 120 having the base portion 121 and the lid portion 123 which define the side, at which the air bag 101 is to be deployed, of the housing space 112 of the case 110 housing the air bag 101 is prepared, and the panel base member 131, of the instrument panel 130, to be welded to the retainer 120 is prepared. Then, the temperatures of the leading ends of the ribs 120b and 131c of the retainer 120 and the panel base member 131 are raised to a predetermined temperature to be melted by an infrared welding machine. Next, by use of a jig, the retainer 120 and the panel base member 133 each having the melted leading ends are moved relative to each other in a horizontal direction (pressurizing direction) in which the retainer 120 and the panel base member 131 come closer to each other, whereby the weld end faces 120c and the weld end faces 131d of the ribs 120b and the ribs 131c are brought into contact with each other in a direction perpendicular to the weld end faces 120c and 131d, and pressurized. By this technique, the air bag mounting interior trim 100 having the ribs 120b and the ribs 131c of the retainer 120 and the instrument panel 130 welded to each other through infrared welding is produced.

Next, operation of the air bag mounting interior trim 100 of the present application example is described.

In the air bag mounting interior trim 100, when the air bag 101 is inflated to be deployed by being supplied with gas from the inflator 102, the lid portion 123 of the retainer 120, firstly, rotates so as to open by being pressed from the back surface side thereof toward the surface side thereof. Then, when this rotation of the lid portion 123 occurs, the instrument panel 130 tears open along the tear lines 131a of the panel base member 131 due to the rotation, whereby the air bag 101 expands into the compartment through the gap generated as a result of the tear opening. Thus, the air bag 101 having expanded into the compartment protects the occupant of the vehicle.

In the air bag mounting interior trim 100 of the present application example, the retainer 120 holding the case 110 housing the air bag 101, and the instrument panel 130 configured to have the retainer 120 mounted thereto are joined to each other through infrared welding. The infrared welding is performed in a state in which: the weld end face 120c of each rib 120b of the retainer 120 and the weld end face 131d of a corresponding rib 131c of the panel base member 131 of the instrument panel 130 face each other in a parallel manner; and the facing direction is aligned with the pressurizing direction in which the retainer 120 and the panel base member 131 are moved relative to each other at the time of assembly thereof.

In this structure, all of the ribs 120b and 131c including the ribs 120b and 131c formed at the inclined faces 120a and 131b of the retainer 120 and the panel base member 131 have the weld end faces 120c and 131d facing the pressurizing direction in which the retainer 120 and the panel base member 131 are moved relative to each other at the Lime of assembly thereof. That is, the weld end faces 120c and 131d of all of the ribs 120b and 131c are the faces each extending in a direction perpendicular to the pressurizing direction realized at the time of assembly of the retainer 120 and the panel base member 131. Thus, the weld end faces 120c and 131d of the ribs 120b and 131c (especially, the ribs 120b and 131c formed at the inclined faces 120a and 131b) are not the faces each extending inclined with respect to the pressurizing direction described above. Thus, each weld end face 120c and a corresponding weld end face 131d are prevented from being pressurized in a direction inclined with respect to the weld end face 120c and the weld end face 131d at the time of welding thereof, and are pressurized in a direction perpendicular to the weld end face 120c and the weld end face 131d.

Therefore, according to the air bag mounting interior trim 100 of the present application example, even in a case where the ribs 120b and 131c for welding the retainer 120 and the instrument panel 130 are formed at the inclined faces 120a and 131b each having a large inclination angle with respect to the vertical direction, welding pressure necessary for welding the retainer 120 and the instrument panel 130 is caused to efficiently act between the weld end faces 120c and the weld end faces 131d, and welding of the ribs 120b and the ribs 131c is reliably performed in an appropriately pressurized state. That is, the ribs 120b and the ribs 131c including the ribs provided at the inclined faces 120a and 131b of the retainer 120 and the instrument panel 130 are efficiently pressurized to be welded to each other.

In addition, since the retainer 120 and the panel base member 131 of the instrument panel 130 are joined to each other through infrared welding, the retainer 120 and the panel base member 131 are reliably integrated to each other.

Meanwhile, in the second application example described above, each rib 120b of the retainer 120 and a corresponding rib 131c of the panel base member 131 of the instrument panel 130, both ribs 120b, 131c melted by infrared radiation, are welded to each other by the weld end face 120c and the weld end face 131d being pressurized while being in contact with each other in a direction perpendicular to the weld end face 120c and the weld end face 131d. In a structure where the rib width of the rib 120b and the rib width of the rib 131c are not different from each other and the leading end shapes of the ribs 120b and 131c are not pointed shapes, the weld end face 120c and weld end face 131d are pressed under substantially uniform pressure throughout the entire region of the contact surface when infrared welding is performed as described above. When the entire region of the contact surface is pressed under substantially uniform pressure, the leading end of one of the rib 120b and the rib 131c is difficult to go into the weld end face 120c or 131d of the other of the rib 120b and the rib 131c to form a recessed portion therein. Thus, in the structure described above, the contact area of the leading ends of the rib 120b and the rib 131c is not ensured, and the leading end of one of the rib 120b and the rib 131c is not surrounded by the other of the rib 120b and the rib 131c. Thus, the welding strength or the joining strength between the rib 120b and the rib 131c remains small.

Thus, in order to improve the welding strength or the joining strength between each rib 120b and a corresponding rib 131c, the rib 120b and the rib 131c may be welded to each other in a state where the leading end of either one of the rib 120b and the rib 131c is fitted in a recessed portion formed in the weld end face 120c or 131a of the other of the rib 120b and the rib 131c.

For example, as shown in FIG. 17, the retainer 120 and the panel base member 131 of the instrument panel 130 are formed such that a rib width W2 of the rib 131c of the panel base member 131 is smaller than a rib width W1 of the rib 120b of the retainer 120. The rib width W1, W2 is the dimension in a direction perpendicular to the protruding direction of the rib 120b, 131c, and specifically is the dimension in the up-down direction of the rib 120b, 131c. Then, the leading ends of each rib 120b and each rib 131c of the retainer 120 and the panel base member 131 are melted by an infrared welding machine. Next, by use of a jig, the retainer 120 and the panel base member 131 each having the melted leading ends are moved relative to each other in a horizontal direction (pressurizing direction) in which the retainer 120 and the panel base member 131 come closer to each other, whereby the weld end face 120c and the weld end face 131d of the rib 120b and the rib 131c are brought into contact with each other in a direction perpendicular to the weld end face 120c and the weld end face 131d, and pressurized.

When the rib 120b and the rib 131c are pressurized as above, the rib 131c, of the panel base member 131, having a smaller rib width presses a part of the weld end face 120c of the rib 120b, of the retainer 120, having a greater rib width, whereby stress is concentrated. Thus, as shown in FIG. 18, a recessed portion 120d is formed in the weld end face 120c of the melted rib 120b, and at the same time, the leading end of the rib 131c enters the recessed portion 120d to be fitted therein. At this time, the rib 120b and the rib 131c are welded to each other in a state where the leading end of the rib 131c is fitted in the recessed portion 120d formed in the weld end face 120c of the rib 120b. Thus, in the structure of this modification, the contact area between the leading ends of the rib 120b and the rib 131c is increased and the leading end of one of the rib 120b and the rib 131c is caused to be surrounded by the other of the rib 120b and the rib 131c. Thus, the welding strength or the joining strength between the rib 120b and the rib 131c is improved. Thus, the rib 120b and the rib 131c are further efficiently pressurized to be welded to each other.

Alternatively, for example, as shown in FIG. 19, the panel base member 131 of the instrument panel 130 is formed such that each rib 131c thereof has a pointed end portion 131e at the leading end thereof. Then, the leading ends of each rib 120b sand each rib 131c of the retainer 120 and the panel base member 131 are melted by an infrared welding machine. Next, by use of a jig, the retainer 120 and the panel base member 131 each having the melted leading ends are moved relative to each other in a horizontal direction (pressurizing direction) in which the retainer 120 and the panel base member 131 come closer to each other, whereby the weld end face 120c of the rib 120b and the outer face of the pointed end portion 131e of the rib 131c are brought into contact with each other in a direction perpendicular to the weld end face 120c, and pressurized.

When the rib 120b and the rib 131c are pressurized as above, the pointed end portion 131e of the rib 131c ununiformly presses the weld end face 120c of the rib 120b, whereby stress is concentrated. Thus, as shown in FIG. 20, a recessed portion 120e is formed in the weld end face 120c of the melted rib 120b, and at the same time, the pointed end portion 131e of the rib 131c enters the recessed portion 120e to be fitted therein. In this case, the rib 120b and the rib 131c are welded to each other in a state where the pointed end portion 131e of the rib 131c is fitted in the recessed portion 120e formed in the weld end face 120c of the rib 120b. Thus, also in the structure of this modification, the contact area between the leading ends of the rib 120b and the rib 131c is increased and the leading end of one of the rib 120b and the rib 131c is caused to be surrounded by the other of the rib 120b and the rib 131c. Thus, the welding strength or the joining strength between the rib 120b and the rib 131c is improved. Thus, the rib 120b and the rib 131c are further efficiently pressurized to be welded to each other.

In the modification shown in FIG. 19 and FIG. 20 described above, the rib width is not different between the rib 120b of the retainer 120 and the rib 131c of the panel base member 131. However, the modification shown in FIG. 19 and FIG. 20 may be combined with the modification shown in FIG. 17 and FIG. 18 described above to provide a difference in the rib width between the rib 120b and the rib 131c, thereby further improving the welding strength or the joining strength between the rib 120b and the rib 131c.

When each rib 120b and a corresponding rib 131c of the retainer 120 and the panel base member 131 are to be welded to each other in a state where the leading end of either one of the rib 120b and the rib 131c is fitted in a recessed portion formed in the weld end face 120c or 131d of the other of the rib 120b and the rib 131c, the leading end of the rib 131c of the panel base member 131 may be fitted in the recessed portion in the weld end face 120c of the rib 120b of the retainer 120 as in the two modifications shown in FIG. 17 to FIG. 20 described above, but instead, the leading end of the rib 120b of the retainer 120 may be fitted in a recessed portion in the weld end face 131d of the rib 131c of the panel base member 131.

In order to appropriately perform welding of each rib 120b and a corresponding rib 131c of the retainer 120 and the panel base member 131, the rib 120b, 131c of which material has a great hardness during pressurization is effectively used as the rib 120b, 131c having a smaller rib width or having a pointed leading end, and the rib 131c, 120b of which material has a small hardness during pressurization is effectively used as the rib 131c, 120b having a greater rib width or having a flat leading end face. The reason is that the rib 120b, 131c of which material has a great hardness during pressurization easily goes into the weld end face 131d, 120c of the rib 131c, 120b of which material has a small hardness during pressurization, and thus, the rib 120b and the rib 131c are easily joined to each other. An example of the material having a great hardness includes super olefin polymer (TSOP), and an example of the material having a small hardness includes polyolefin-based soft resin (TPO).

In order to improve the welding strength or the joining strength between each rib 120b and a corresponding rib 131c of the retainer 120 and the panel base member 131, the technique of welding the rib 120b and the rib 131c to each other in a state where the leading end of either one of the rib 120b and the rib 131c is fitted in the recessed portion formed in the weld end face 120c or 131d of the other of the rib 120b and the rib 131c as in the two modifications shown in FIG. 17 to FIG. 20 described above may be applied to the configuration of the first application example described above.

In the second application example described above, the air bag mounting interior trim 100 is assumed to be applied to an air bag device for vehicles, the air bag device being configured such that the air bag 101 is housed at the front side with respect to the instrument panel 130 present forward of the occupant, i.e., the air bag 101 is disposed forward of the target occupant, and the target occupant is protected by the air bag 101 being inflated to be deployed to the rear side (to the inner side of the compartment). However, the present invention is not limited thereto, and may be applied to an air bag device for vehicles, or the like, the air bag device being configured such that the air bag is housed at a lateral side with respect to a left/right door trim panel of the vehicle body, and the target occupant is protected by the air bag being inflated to be deployed to the lateral side (to the inner side of the compartment). Alternatively, the present invention may be applied to a glove box or the like.

The present invention is not limited to the embodiments, the modifications, and the application examples described above, and may be modified in various manners without departing from the gist of the present invention.

1. A resin molded component comprising:
a body portion; and
a rib protruding from the body portion and configured to be welded to a predetermined resin component through infrared welding,
the body portion and the rib being molded integrally with each other,
the resin molded component having a foamed layer formed at least in the body portion, wherein
a leading end portion of the rib has a thinned remainder which has been thinned relative to a root portion of the rib.

2. The resin molded component according to claim 1, wherein
a rib width of the thinned remainder of the rib is smaller than a rib width of the root portion.

3. The resin molded component according to claim 1, wherein
the leading end portion of the rib is a low-foamed portion in which foaming is suppressed compared to foaming in the foamed layer.

4. The resin molded component according to claim 3, wherein
the low-foamed portion extends over an entire region of a melted region in which the rib is melted during infrared welding.

5. A method for producing a resin molded component, the method comprising:
a filling step of filling a foamable resin material in a void in a die for molding the resin molded component according to claim 3; and
a foamed-layer forming step of forming the low-foamed portion at the leading end portion of the rib while forming the foamed layer in the resin molded component by performing a core-back operation on the die after filling the resin material.

6. A method for producing a welded resin-molded article, the method comprising:
a melting step of melting the rib and the predetermined resin component by applying infrared radiation to a leading end of the rib of the resin molded component and the predetermined resin component according to claim 1 and;
a joining step of joining the rib and the predetermined resin component by pressure welding the melted rib and the melted predetermined resin component to each other.

7. The method for producing the welded resin-molded article according to claim 6, wherein
the leading end portion of the rib is a low-foamed portion in which foaming is suppressed compared to foaming in the foamed layer, and
melting of the rib in the melting step is performed such that a melted region is within a range of the low-foamed portion.
